(19) United States
(12) Patent Application Publication
(10) Pub. No.: US 2025/0242647 A1
(43) Pub. Date: Jul. 31, 2025

(54) ADDITIVELY MANUFACTURED JOUNCE BUMPER WITH DIFFERENT INTERNAL PROPERTIES

(71) Applicant: Ford Global Technologies, LLC, Dearborn, MI (US)

(72) Inventors: Keith Weston, Canton, MI (US); David D. Friske, Wolverine Lake, MI (US); Michael Joseph Niksa, Royal Oak, MI (US)

(21) Appl. No.: 18/423,513

(22) Filed: Jan. 26, 2024

(51) Int. Cl. B60G 7/04; B33Y 80/00

(52) U.S. Cl. CPC B60G 7/04; B33Y 80/00; B60G 2204/4502

(57) ABSTRACT

A jounce bumper for a vehicle suspension system may include a first body portion made of a first material disposed at a first end of the jounce bumper extending over a first longitudinal distance along a longitudinal centerline of the jounce bumper and a second body portion made of a second material disposed at a second end of the jounce bumper to extend over a second longitudinal distance along the longitudinal centerline of the jounce bumper. The first material may have a different hardness than the second material such that force versus displacement characteristics for resistance to compression over the first and second longitudinal distances are different.

### TECHNICAL FIELD

Example embodiments generally relate to vehicle suspension and, more particularly, relate to a suspension system with a jounce bumper that may have specifically tailored properties such as with respect to internal hardness properties.

### BACKGROUND

Vehicles commonly employ independent suspension systems that allow each wheel to move relative to the vehicle chassis independent of the other wheels. The components and geometries used for independent suspension designs can vary to some degree. However, a typical independent suspension system will employ dampers or shock absorbers (or simply “shocks”) that are designed to provide damping for ride quality enhancement. The shocks generally resist compression and rebound with damping forces that are applied over a range of travel of a piston rod. The shocks selected for a particular vehicle are generally chosen based on the expectation of normal ride scenarios that are encountered during routine driving conditions. Some typical suspension components that may be considered for selection include springs and dampers (e.g., gas shocks).

In addition to shocks, many suspension systems also employ jounce bumpers (i.e. bump stops). Jounce bumpers and rebound stops are known to reduce the contact force on the suspension components when under full compression or rebound from abrupt changes in driving conditions. In some cases, jounce bumpers are embodied as blocks of rubber or some other shock absorbent material that are placed somewhere between the axle tube that connects to the wheel (or wheel assembly) and the body of the vehicle to prevent contact therebetween. However, other locations are also possible, and jounce bumpers may also be employed on other suspension systems as well. These jounce bumpers, although useful even if produced merely from a unitary block of rubber, may have expanded utility if structured in a more complex way. In this regard, the more complex structuring may enable the provision of finely tuned or uniquely defined properties, which may vary based on location within the overall structure, as discussed below.

### BRIEF SUMMARY OF SOME EXAMPLES

In accordance with an example embodiment, a jounce bumper for a vehicle suspension system may be provided. The jounce bumper may include a first body portion made of a first material disposed at a first end of the jounce bumper extending over a first longitudinal distance along a longitudinal centerline of the jounce bumper and a second body portion made of a second material disposed at a second end of the jounce bumper to extend over a second longitudinal distance along the longitudinal centerline of the jounce bumper. The first body portion may have a different hardness than the second body portion such that force versus displacement characteristics for resistance to compression over the first and second longitudinal distances are different.

In another example embodiment, a suspension system for a vehicle may be provided. The suspension system may include a body of the vehicle, and a damping assembly operably coupling a wheel assembly and the body to dampen movement of the body of the vehicle responsive to jounce and rebound events experienced at the wheel assembly. The damping assembly may include a jounce bumper including a first body portion made of a first material disposed at a first end of the jounce bumper extending over a first longitudinal distance along a longitudinal centerline of the jounce bumper and a second body portion made of a second material disposed at a second end of the jounce bumper to extend over a second longitudinal distance along the longitudinal centerline of the jounce bumper. The first body portion may have a different hardness than the second body portion such that force versus displacement characteristics for resistance to compression over the first and second longitudinal distances are different.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a block diagram of a vehicle suspension system including a jounce bumper in accordance with an example embodiment;

FIG. 2A illustrates a cross sectional view of a jounce bumper in accordance with an example embodiment;

FIG. 2B illustrates a plot of load versus deflection achievable via the jounce bumper in accordance with an example embodiment;

FIG. 3 illustrates the jounce bumper being provided with piezoelectric material to power a lighting element or recover energy for a battery in accordance with an example embodiment;

FIG. 4 illustrates the jounce bumper being provided with functional metallic ink material to define a sensor or sensor suite in communication with monitoring circuitry in accordance with an example embodiment;

FIG. 5 illustrates an alternative structure for portions of a jounce body of the jounce bumper in accordance with an example embodiment;

FIG. 6 illustrates a cross sectional view of a jounce bumper having at least one section with a lattice structure having different sized voids in accordance with an example embodiment; and

FIG. 7 illustrates a cross sectional view of a jounce bumper having at least one section with a lattice structure having the same sized voids in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments described herein may enhance the performance of a generically structured jounce bumper described above. In this regard, for example, some embodiments may employ additive manufacturing techniques to create various lattice structures and multi-material solutions to provide variable rate characteristics to jounce bumpers that may deliver enhanced ride quality and chassis protection.

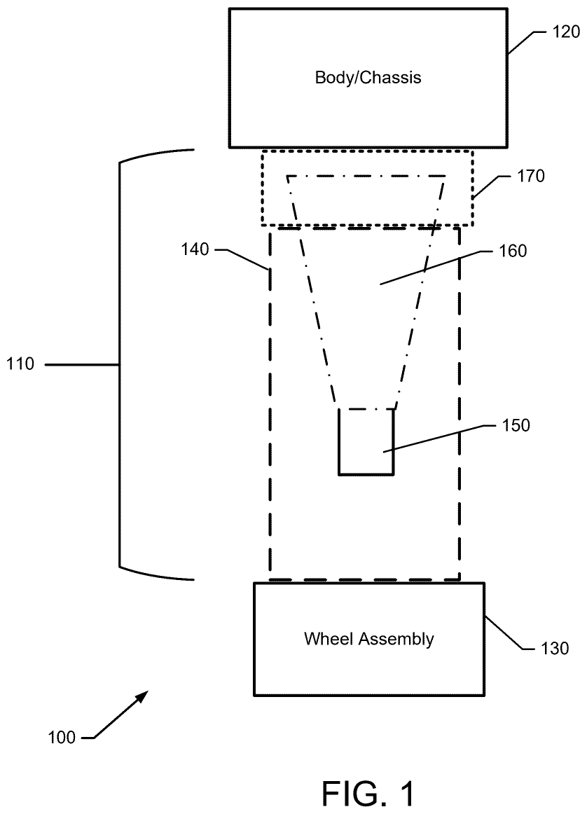

FIG. 1 illustrates a block diagram of a vehicle suspension system 100 employing a damping assembly 110. The damping assembly 110 may be used to dampen jounce and rebound forces that may be initiated between a body or chassis 120 of the vehicle and a wheel assembly 130 (which may include each individual wheel and other suspension system components that support the corresponding wheels). Bumps or obstacles in a terrain over which a vehicle is being operated may cause the wheel and wheel assembly 130 to articulate varying amounts depending on how the vehicle is driven and the size of the obstacle in the terrain. Thus, the vehicle's suspension system 100 may reach full compression at certain points depending on the articulation distance the wheel assembly 130 may be required to travel. In other words, the wheel assembly 130 may be forced towards the chassis 120 and at this point the suspension system 100 may be at full compression. Thus, there may be potential for the wheel assembly 130 to impart a significant jounce force on other components in the suspension system 100. The wheel assembly 130 making contact with other elements of the suspension system 100 may lead to the components of the suspension system 100 imparting unwanted forces on each other. In this regard, the damping assembly 110 may be prevent or mitigate any such contact from occurring to components of the suspension system 100 as a result of jounce forces from the wheel assembly 130.

In some embodiments, the damping assembly 110 operably couples the chassis 120 to the wheel assembly 130. The damping assembly 110 may include a spring 140, a jounce bumper 150, a reinforcement member 160, and a spring isolator 170. In some embodiments, the vehicle suspension system 100 may also include a shock absorber (not pictured) that may be separate from the damping assembly 110, and may also operably couple the chassis 120 to the wheel assembly 130. The spring 140 may be configured to compress or decompress responsive to the wheel assembly 130 articulation as the vehicle traverses uneven terrain. The spring 140 may therefore be disposed such that a first end of the spring 140 is operably coupled to the chassis 120 (e.g., via the spring isolator 170), and a second end of the spring 140 may be operably coupled to the wheel assembly 130. Other intermediate components may also be understood to be provided at the first and second ends of the spring 140 in some cases.

The spring 140 (e.g., a coil spring, coil over spring, leaf spring, torsion spring, air spring, etc.), may also be disposed around the jounce bumper 150 such that the jounce bumper 150 is disposed inside and at a center of the spring 140. However, it should be noted that the jounce bumper 150 may alternatively be located outside of the spring 140 at another portion of the chassis 120 in other cases. Thus, example embodiments should not be considered to be limited to the use of the jounce bumper 150 in combination with the spring 140, much less being disposed inside of the spring 140. In other embodiments, the jounce bumper 150 may simply be located on one component or portion of the chassis 120 or wheel assembly 130, and prevent direct contact of such component or portion of the chassis 120 or wheel assembly 130 with the other component/assembly. Furthermore, in some cases, the jounce bumper 150 may be encased within a fluid medium for internal jounce bumpers.

In some embodiments, the spring 140 may be designed to compress a predetermined amount before the wheel assembly 130 (or a portion thereof) comes into contact with the jounce bumper 150. In this regard, the jounce bumper 150 (and the reinforcement member 160) may extend to a total length that is less than the distance between the first end and the second end of the spring 140. Accordingly, the jounce bumper 150 may not be engaged as a result of the wheel assembly 130 articulating a small amount due to the vehicle traversing a small obstacle. Thus, for example, the jounce bumper 150 may only make contact with the wheel assembly 130 when the wheel assembly 130 articulates a relatively large amount due to the magnitude of force exerted thereon being sufficient to drive such contact. In this regard, the jounce bumper 150 may act as a backup feature to be used as protection for extreme jounce events, and is different from a shock absorber designed to provide a smoother ride for the vehicle during normal ride conditions.

The reinforcement member 160 may operably couple to the jounce bumper 150 to the chassis 120, but need not necessarily perform a strictly reinforcing function and could instead simply be considered a base member (or be omitted such that the jounce bumper 150 is directly mounted to the chassis 120). The reinforcement member 160 may be structured to further distribute and dampen jounce forces from the jounce bumper 150. The reinforcement member 160 may also be configured to secure the jounce bumper 150 in a proper functioning position at the center of the spring 140 (or at some other portion of the chassis 120). In some embodiments, the reinforcement member 160 may be conical in shape. The reinforcement member 160 may be operably coupled to the jounce bumper 150 at a narrow end, and may get wider moving away from the operable coupling with the jounce bumper 150 and towards the chassis 120 at a wide end of the reinforcement member 160. However, other structures for the reinforcement member 160 may alternatively be employed and, in some cases, the reinforcement member 160 may essentially just be a portion of the chassis 120, as noted above. When employed, the reinforcement member 160 may be formed from a metallic material in order to provide adequate rigidity and strength to ensure the jounce bumper 150 can withstand large repeated jounce forces.

In cases employing the spring 140, the reinforcement member 160 may be operably coupled to the spring isolator 170 at one end of the reinforcement member 160. In this regard, a portion of the reinforcement member 160 may extend into, and may be integrated with, the spring isolator 170. In some embodiments, the spring isolator 170 may be disposed between the chassis 120 and the first end of the spring 140. As such, the spring isolator 170 may be fixedly operably coupled to the spring 140 such that the spring isolator 170 isolates the chassis 120 from the spring 140. In this regard, the forces generated by the compression of the spring 140 may not be directly transferred to the chassis 120, but rather may be transferred indirectly via the spring isolator 170. In some embodiments, the spring isolator 170 may comprise a rubber or composite material that is compressible, or some other type of shock absorbent material, which may help isolate the chassis 120 from the forces and vibrations transferred through the spring 140 from the wheel assembly 130. In some embodiments, the spring isolator 170 may be shaped like a ring, where the center of the spring isolator 170 may be open. On the outer edge of the spring isolator 170, where the spring isolator 170 contacts the spring 140, there may be a lip configured to operably couple to the first end of the spring 140. The lip may be formed so that the spring 140 naturally rests within the lip of the spring isolator 170.

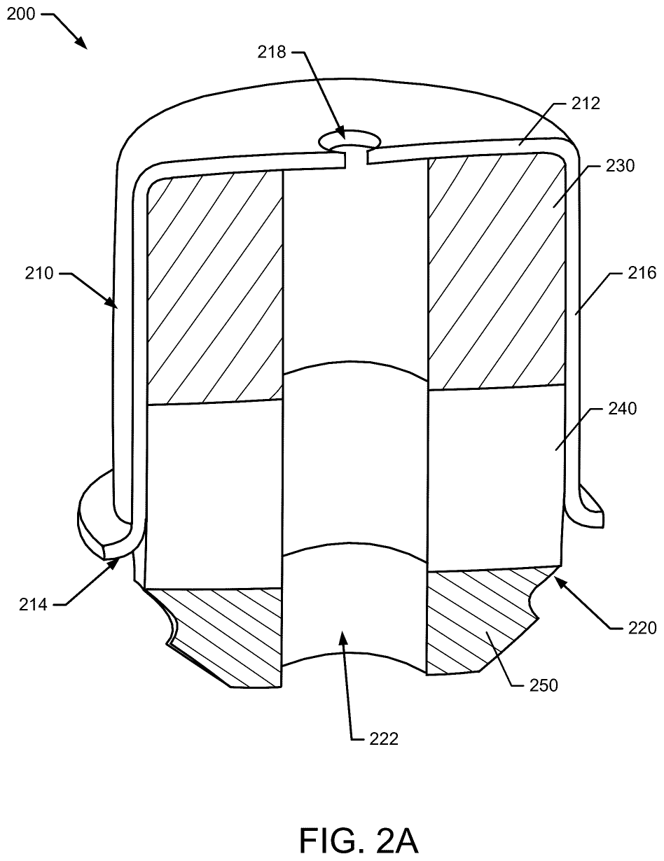

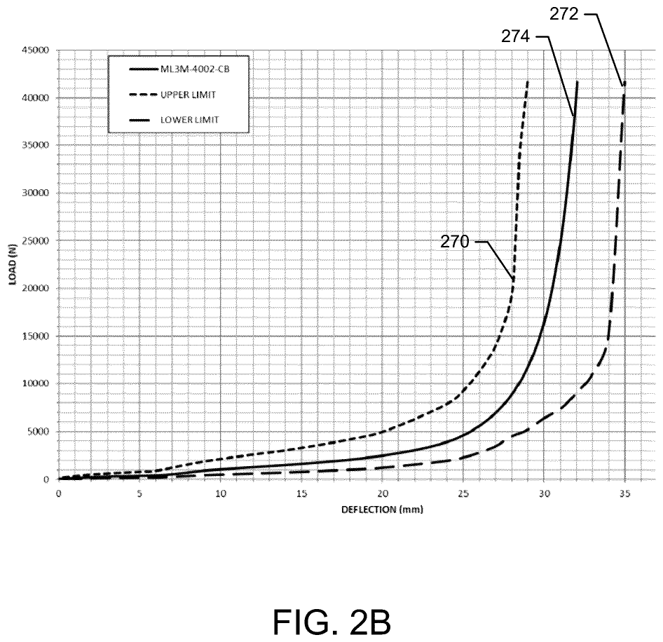

FIG. 2A shows a specific example of some structures that may be employed to instantiate the jounce bumper 150 described above. In this regard, a jounce bumper 200, which is illustrated in FIG. 2A, is simply one specific example structure that may be used in the context shown in FIG. 1, or in other structural arrangements as noted above. The jounce bumper 200 may include a retaining sleeve 210, which is sometimes referred to as a “jounce cup,” and a jounce body 220. The retaining sleeve 210 of this example includes a closed end 212 and an open end 214, and cylindrical sidewalls 216 therebetween. The closed end 212 of this example includes a coupling receiver 218 through which a fastener may be provided to operably couple the retaining sleeve 210 to a portion of the chassis 120 (or the reinforcement member 160) of FIG. 1.

The jounce body 220 of some embodiments may have a substantially cylindrical shape, and may be sized to fit within (or even conform to) the inside of the retaining sleeve 210. In some embodiments, the jounce body 220 and/or the retaining sleeve 210 may include anti-rotation features or other retention features (e.g., protrusions and complementary receiving slots) that prevent rotation of the jounce body 220 within, or removal of the jounce body 220 from, the retaining sleeve 210. To further facilitate receiving the fastener mentioned above for coupling the retaining sleeve 210 to the portion of the chassis 120 (or the reinforcement member 160) of FIG. 1 mentioned above, the jounce body 220 may include a central cavity 222 that extends along a longitudinal centerline of the jounce body 220. In this regard, the fastener may pass through the central cavity 222 to engage the retaining sleeve 210 via the coupling receiver 218.

The jounce body 220 itself, in a conventional jounce bumper, would typically be made of a single and uniform slightly compressible material (e.g., rubber, plastic, nylon, or various other such materials including thermoplastic polyurethane (TPU)). However, in accordance with example embodiments, characteristics of the jounce body 220 may be different at different portions thereof in order to define different compression characteristics (and other features as well) based on the differences, or at least non-uniform nature of the different portions of the jounce body 220. The location of boundaries between these different portions may vary across different embodiments, but some examples are specifically shown below, and others will be readily apparent as well based on this disclosure.

Notably, the jounce body 220 may be located in different contexts (other than the retaining sleeve 210). In this regard, as noted above, the jounce body 220 may be encased in fluid when implemented as an internal jounce bumper. In such examples, the jounce body 220 may employ variable geometric properties that be leveraged to use the fluid medium for different and desirable hysteretic and damping effects.

In the example of FIG. 2A, which shows a cross section view with a portion of both the jounce body 220 and retaining sleeve 210 removed, the part of the jounce body 220 that is shaped to fit within the retaining sleeve 210 is itself split into two portions (e.g., a first base portion 230 and a second base portion 240). The first and second base portions 230 and 240 each have a cylindrical shape and, therefore ultimately have a ring shape since the central cavity 222 passes through a center and hollows out the center of each of them. A proximal end of the first base portion 230 may be adjacent to the closed end 212 of the retaining sleeve 210 and a distal end of the first base portion 230 may be attached to a proximal end of the second base portion 240. Thus, the first base portion 230 may extend a first longitudinal distance away from the closed end 212 toward the second base portion 240. The distal end of the second base portion 240 may, in some cases, extend partially out of the open end 214 of the retaining sleeve 210, and therefore extend a second longitudinal distance away from the closed end 212 and the first base portion 230.

The remaining part of the jounce body 220 (e.g., extension portion 250) may be attached to the distal end of the second base portion 240, and therefore also extends out of the retaining sleeve 210 a third longitudinal distance away from the closed end 212 and the first and second base portions 230 and 240. The extension portion 250 may have a different shape than other parts of the jounce body 220 and therefore not be a cylindrical ring. However, the specific shape is not limited. In an example embodiment, each of the first base portion 230, the second base portion 240 and the extension portion 250 may be made of a different type of material, and may be constructed via additive manufacturing.

Additive manufacturing, which is sometimes referred to as 3D printing, constructs a three dimensional (3D) object from a 3D computer model using materials such as metals, ceramics, plastics, liquids and powders that are fused or added together, typically layer by layer. In the context of the jounce body 220 of FIG. 2A, the first base portion 230 may initially be constructed of a first material (or combination of materials) layer by layer, and the second base portion 240 may thereafter be built atop the first base portion 230, again layer by layer, from a second material that is different than the first material. Thereafter, the extension portion 250 may then be built atop the second base portion 240, again layer by layer, from a third material that may be different than the first material and the second material. However, it is equally possible to build the jounce body 220 in the reverse order (i.e., extension portion 250, then the second base portion 240 and then the first base portion 230).

By using additive manufacturing, the designer may have great flexibility in relation to defining specific characteristics of the respective different portions of the jounce body 220 so that different response characteristics may be achieved. In this regard, for example, the durometer or hardness levels of the first, second and third materials in the first base portion 230, the second base portion 240 and the extension portion 250, respectively, may be selected to be different (e.g., increasing or decreasing in order), and therefore the flexibility or compressibility of each of the portions may be tailored precisely to different use cases. The materials selected for each respective one of the first base portion 230, the second base portion 240 and the extension portion 250 may therefore be selected to define rate rings that have different resistance to compression that may be tuned to desired values or rates of force versus displacement. In some embodiments, for example, TPU materials with different durometer or hardness properties may be selected to change the load required to deflect the material or compress it in dependence on its location within the jounce body 220. For example, the force required to achieve a deflection in a first range (e.g., less than 25 mm) may be relatively small as the extension portion 250 (which may have a lowest force versus displacement characteristic indicating a low amount of force needed to achieve a given displacement) is compressed. The force required to achieve a deflection in a second range (e.g., between 25 mm and 35 mm) may be a bit larger as the second base portion 240 is compressed. Finally, the force required to achieve a deflection in a third range (e.g., greater than 35 mm) may be a bit larger as the first base portion 230 is compressed. FIG. 2B shows a plot of load versus deflection for a given material with a first curve 270 being the lower limit, a second curve 272 being the upper limit, and a third curve being the nominal response for a given material.

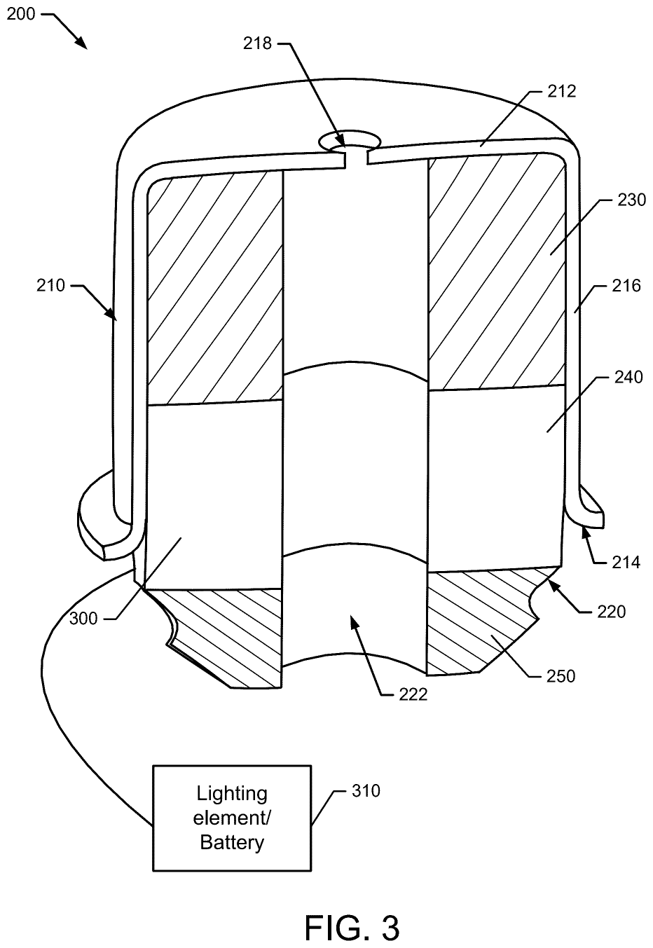

Selecting material properties for the first, second and third materials of the first base portion 230, the second base portion 240 and the extension portion 250, respectively, to control flexibility and compressibility influencing force versus displacement or resistance to compression are not the only characteristics that can be tailored via the structural modifications that are enabled by example embodiments. In this regard, for example, by employing piezoelectric material 300 (as shown in FIG. 3) or some other energy generating material as one or more of the first, second and third materials of the first base portion 230, the second base portion 240 and the extension portion 250, respectively, lighting and/or energy recovery may be achieved. In this regard, for example, the piezoelectric material 300 of FIG. 3 is used to power an external lighting element/battery 310, which may be located proximate to the jounce bumper 200 without an external power supply (e.g., the vehicle battery). Notably, although FIG. 3 shows the second base portion 240 including the piezoelectric material 300, the piezoelectric material could also or alternatively be provided in the first base portion 230 or the extension portion 250.

Photoluminescent materials such as LumiLor® may be placed proximate to the piezoelectric material 300 and powered thereby to place relatively thin (e.g., micron thicknesses) materials at locations nearby the suspension components at which the jounce bumper 200 is located. The photoluminescent materials may define patterns, logos, words, branding, patterns, trail maps and numerous other designs that may be of interest to vehicle owners. Light emitting diodes (LEDs) and other lighting solutions or laser perforations may also or alternatively be employed. By omitting the use of an external power supply, inclusion of additional wiring and increased battery loading may be prevented. Thus, more efficient lighting effects may be achieved, particularly in the areas of suspension components and/or chassis lighting. As noted above small local batteries or energy sources may also be charged or supplemented with energy generated by the piezoelectric material 300.

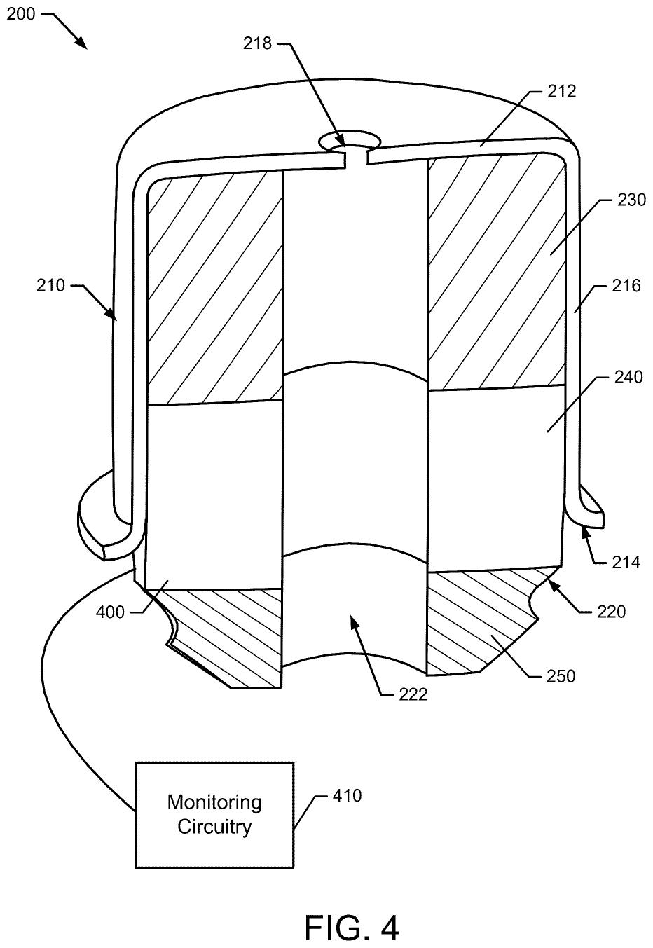

In other example embodiments, one more of the first base portion 230, the second base portion 240 and the extension portion 250 may additionally or alternatively be provided with functional metallic ink 400 or other materials that can be used to integrate sensors directly into components made via additive manufacturing. Liquid X® is one example of such a material, which may be used to define thin metal films or traces that can be formed into sensors that may be operably coupled to monitoring circuitry 410. The monitoring circuitry 410 may provide data acquisition for racing applications, active suspension telemetry, or other uses. In some cases, the functional metallic ink 400 may be integrated into the material of one or more of the first base portion 230, the second base portion 240 and the extension portion 250 to define a suite of sensors that can be efficiently integrated and operated for suspension component monitoring and/or control. The monitoring circuitry 410 may therefore, for example, provide outputs that are used to control vehicle shock absorber performance at or near the end of travel. Notably, although FIG. 4 shows the second base portion 240 including the functional metallic ink 400, the functional metallic ink 400 could also or alternatively be provided in the first base portion 230 or the extension portion 250.

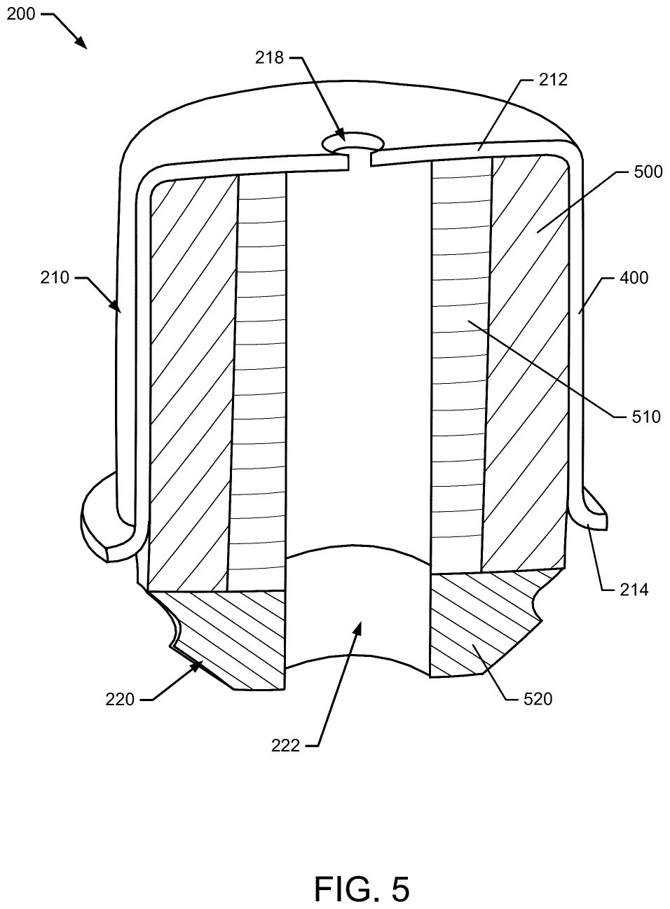

Also, instead of strictly structuring rate rings to be vertically separated, radial separation may be possible as shown in FIG. 5. In this regard, an outer ring 500 and an inner ring 510 may each have different properties. For example, the outer ring 500 may have piezoelectric material and the inner ring 510 may have functional metallic ink, whereas the extension portion 520 may have a different durometer than the inner and outer rings 510 and 500 to define different rates of force versus displacement for the jounce body 220. The example of FIG. 5 may therefore employ multiple different functional enhancements simultaneously.

The use of additive manufacturing techniques may also enable the provision of modifications to the internal structure of any or all of the first base portion 230, the second base portion 240 and the extension portion 250. In this regard, for example, void spaces may be added inside the structure of the first base portion 230, the second base portion 240 and/or the extension portion 250 to define a lattice structure that may be different in each respective portion to further allow tailoring of resistance to compression (or durometer) of the portions that employ the lattice structure. In this regard, the resistance to compression may be very finely tuned to precisely selected values or rates of force versus displacement based on the size, shape or density of the void spaces. Moreover, in some cases, the size or density of the void spaces may change as distance from a longitudinal end of the jounce bumper 200 increases. Thus, for example, a gradient change in the density or size of the void spaces may correspondingly define a change in the hardness or durometer that changes with longitudinal distance away from the closed end 212.

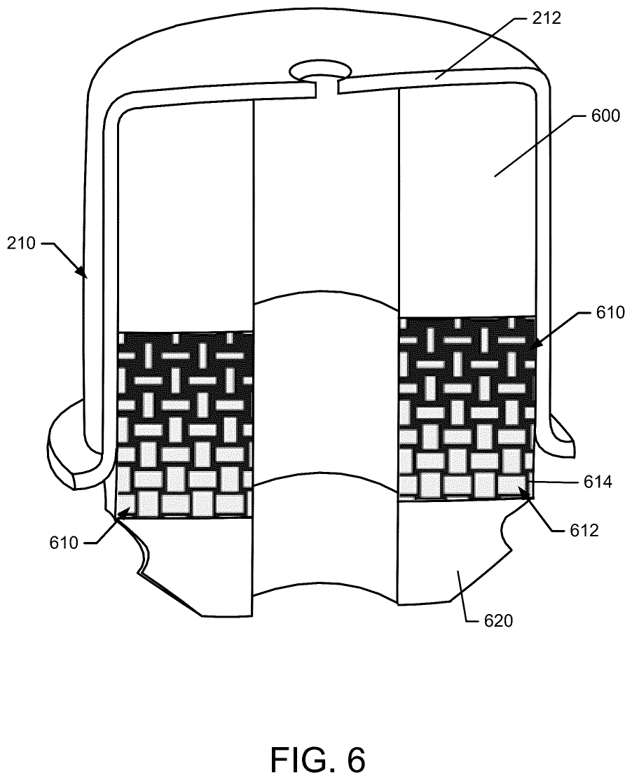

FIG. 6 illustrates an example of changing hardness or durometer, which reduces as distance from the closed end 212 increases. In this regard, a first base portion 600 is proximate to the closed end 212, a second base portion 610 extends away from the first base portion 600 and an extension portion 620 extends away from the second base portion 610 similar to the examples of FIGS. 2A, 3, and 4. However, the second base portion 610 of this example is formed via additive manufacturing to include void spaces 612 that define a lattice structure 614. In this example, the void spaces 612 are smaller closer to the closed end 212 and increase in size as distance from the closed end 212 increases. This reduces the hardness of the second base portion 610 as distance from the closed end 212 increases. Thus, as displacement or deflection due to compression of the second base portion 610 occurs, more force will be required to achieve increasing amounts of deflection over the range of displacement that is attributable to compression of the second base portion 610. Notably, although the second base portion 610 is shown to include the lattice structure 614 in FIG. 6, either or both of the first base portion 600 and the extension portion 620 may also or alternatively employ the lattice structure 614.

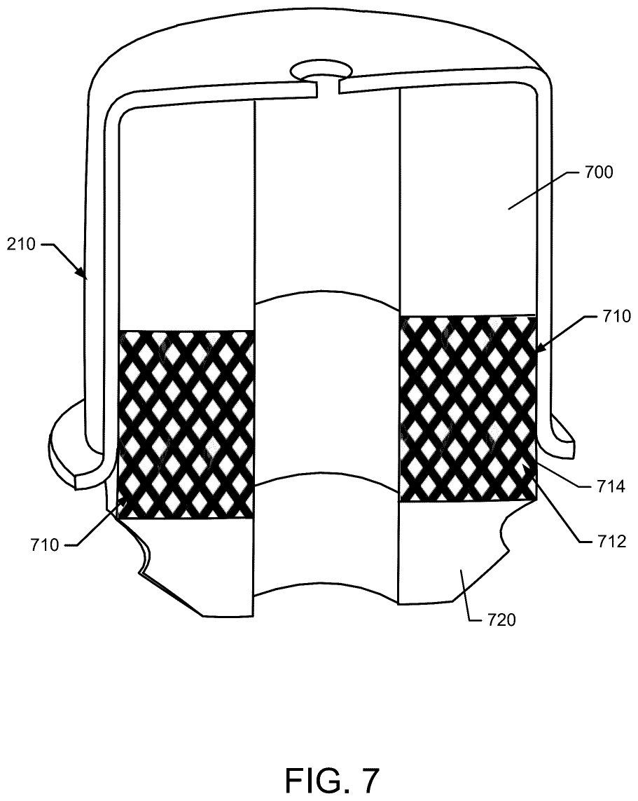

Also, as an alternative to the gradient change in size of the void spaces 612 shown in FIG. 6, consistently sized void spaces may be employed, as shown in the example of FIG. 7. Referring to FIG. 7, a first base portion 700 is proximate to the closed end 212, a second base portion 710 extends away from the first base portion 700 and an extension portion 720 extends away from the second base portion 710 similar to the examples of FIGS. 2A, 3, 4 and 6. However, the second base portion 710 of this example is formed via additive manufacturing to include void spaces 712 that define a lattice structure 714 that is different than that of FIG. 6. In this regard, the void spaces 712 are consistently sized throughout the longitudinal extent of the second base portion 710. While this maintains a similar durometer or hardness throughout the second base portion 710 it may nevertheless allow the same material to be used in two portions (e.g., the first base portion 700 and the second base portion 710) but changing overall hardness or durometer between the respective portions due to the provision of the lattice structure 714. This reduces the hardness of the second base portion 710 relative to the first base portion 700. Thus, as displacement or deflection due to compression of the second base portion 710 occurs, more force will be required to achieve deflection of the first base portion 700. Notably, although the second base portion 710 is shown to include the lattice structure 714 in FIG. 7, either or both of the first base portion 700 and the extension portion 720 may also or alternatively employ the lattice structure 714. Moreover, in some cases, different sized void spaces 712 may be employed to define different lattice structures (which may be differentiated by changing the thicknesses of the lattice members forming the lattice structure 714) in each respective one of the first base portion 700, the second base portion 710 and the extension portion 720.

Notably, although FIGS. 2A, 3, 4, 5, 6 and 7 show the jounce body 220 split into three distinct portions, example embodiments may be practiced with as few as one portion (e.g., with varying gradient void space sizes to change hardness over a range of the longitudinal extent of the jounce body 220). Example embodiments may also be practiced with two distinct portions (to define a changed hardness or durometer in each respective portion), or with more than three distinct portions to define various characteristics of the jounce body 220. Regardless of how structured, the function of multiple components conventionally employed to change force versus distance response can be achieved in a single component that is additively manufactured to include different material properties in respective different portions thereof. Moreover, although jounce bumpers serve as an example of a motion stop (e.g., compression or rebound motion stop) that may employ example embodiments, it should be appreciated that the same principles of design may also apply to rebound stops.

A jounce bumper for a vehicle suspension system may be provided. The jounce bumper may include a first body portion made of a first material disposed at a first end of the jounce bumper extending over a first longitudinal distance along a longitudinal centerline of the jounce bumper and a second body portion made of a second material disposed at a second end of the jounce bumper to extend over a second longitudinal distance along the longitudinal centerline of the jounce bumper. The first and second materials may each be a rubber, plastic, polymer or elastomer. The first body portion may have a different hardness than the second body portion such that force versus displacement characteristics for resistance to compression over the first and second longitudinal distances are different.

The jounce bumper (or a rebound stop or any suspension system including the same) of some embodiments may include additional features, modifications, augmentations and/or the like to achieve further objectives or enhance performance of the device. The additional features, modifications, augmentations and/or the like may be added in any combination with each other. Below is a list of various additional features, modifications, and augmentations that can each be added individually or in any combination with each other. For example, the first and second body portions may each be made via additive manufacturing. In an example embodiment, one or both of the first and second body portions comprises void spaces distributed therein to form a lattice structure. Thus, for example, a shape or density of the lattice structure may determine a hardness value of corresponding portions at which the lattice structure is formed. In some cases, a density or size of the void spaces in the lattice structure may be consistent over the first longitudinal distance or the second longitudinal distance to define a given hardness value that is consistent over the first longitudinal distance or the second longitudinal distance. However, alternatively, a density or size of the void spaces in the lattice structure may change as distance from the first end increases to define a changing hardness value that is decreases as distance from the first end increases. In some cases, one or both of the first and second materials may include a piezoelectric material, which may power a lighting element or a battery disposed proximate to the vehicle suspension system. In an example embodiment, one or both of the first and second materials may include a functional metallic ink material that may be used to define a sensor or sensor suite operably coupled to monitoring circuitry. In an example embodiment, the monitoring circuitry may provide data for suspension component monitoring or control. In some cases, the first and second materials may be different materials with corresponding different hardness values or properties.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A jounce bumper for a vehicle suspension system, the jounce bumper comprising:
a first body portion made of a first material disposed at a first end of the jounce bumper extending over a first longitudinal distance along a longitudinal centerline of the jounce bumper;
a second body portion made of a second material disposed at a second end of the jounce bumper to extend over a second longitudinal distance along the longitudinal centerline of the jounce bumper,
wherein the first body portion has a different hardness than the second body portion such that force versus displacement characteristics for resistance to compression over the first and second longitudinal distances are different.

2. The jounce bumper of claim 1, wherein the first and second body portions are each made via additive manufacturing.

3. The jounce bumper of claim 1, wherein one or both of the first and second body portions comprises void spaces distributed therein to form a lattice structure.

4. The jounce bumper of claim 3, wherein a density or size of the void spaces in the lattice structure is consistent over the first longitudinal distance or the second longitudinal distance.

5. The jounce bumper of claim 3, wherein a density or size of the void spaces in the lattice structure changes as distance from the first end increases.

6. The jounce bumper of claim 1, wherein one or both of the first and second materials comprises a piezoelectric material.

7. The jounce bumper of claim 2, wherein the piezoelectric material powers a lighting element disposed proximate to the vehicle suspension system.

8. The jounce bumper of claim 1, wherein one or both of the first and second materials comprises a functional metallic ink material.

9. The jounce bumper of claim 8, wherein the functional metallic ink material is used to define a sensor or sensor suite operably coupled to monitoring circuitry that provides data for suspension component monitoring or control.

10. The jounce bumper of claim 1, wherein the first and second materials have different hardness properties.

11. A vehicle suspension system, the vehicle suspension system comprising:
a body or chassis of the vehicle; and
a damping assembly operably coupling a wheel assembly of the vehicle and the body chassis to dampen movement of the body or chassis of the vehicle responsive to jounce and rebound events experienced at the wheel assembly,
wherein the damping assembly comprises:
a jounce bumper or rebound stop comprising:
a first body portion made of a first material disposed at a first end of the jounce bumper extending over a first longitudinal distance along a longitudinal centerline of the jounce bumper;
a second body portion made of a second material disposed at a second end of the jounce bumper to extend over a second longitudinal distance along the longitudinal centerline of the jounce bumper,
wherein the first body portion has a different hardness than the second body portion such that force versus displacement characteristics for resistance to compression over the first and second longitudinal distances are different.

12. The vehicle suspension system of claim 11, wherein the first and second body portions are each made via additive manufacturing.

13. The vehicle suspension system of claim 11, wherein one or both of the first and second body portions comprises void spaces distributed therein to form a lattice structure.

14. The vehicle suspension system of claim 13, wherein a density or size of the void spaces in the lattice structure is consistent over the first longitudinal distance or the second longitudinal distance.

15. The vehicle suspension system of claim 13, wherein a density or size of the void spaces in the lattice structure changes as distance from the first end increases.

16. The vehicle suspension system of claim 11, wherein one or both of the first and second materials comprises a piezoelectric material.

17. The vehicle suspension system of claim 12, wherein the piezoelectric material powers a lighting element disposed proximate to the vehicle suspension system.

18. The vehicle suspension system of claim 11, wherein one or both of the first and second materials comprises a functional metallic ink material.

19. The vehicle suspension system of claim 18, wherein the functional metallic ink material is used to define a sensor or sensor suite operably coupled to monitoring circuitry to provide data for suspension monitoring or control.

20. The vehicle suspension system of claim 19, wherein the first and second materials have different hardness properties.
